(19) United States
(12) Patent Application Publication
(10) Pub. No.: US 2019/0172219 A1
(43) Pub. Date: Jun. 6, 2019

(54) 3D IMAGE PROCESSING AND VISUALIZATION WITH ANOMALOUS IDENTIFICATION AND PREDICTIVE AUTO-ANNOTATION GENERATION

(71) Applicant: SAP SE, Walldorf (DE)

(72) Inventor: Aavishkar Bharara, Bangalore (IN)

(21) Appl. No.: 15/828,676

(22) Filed: Dec. 1, 2017

(51) Int. Cl. G06T 7/73; G06T 7/149; G06F 17/15; G06T 19/20; G06T 1/00

(52) U.S. Cl. CPC G06T 7/73; G06T 7/149; G06T 2219/004; G06T 19/20; G06T 1/0007; G06F 17/153

(57) ABSTRACT

A method for three dimensional image processing with predictive auto-annotation generation including receiving sensor raw data captured by an image acquisition system, identifying parameters within the sensor raw data using historical data, creating a union set of the historical data and the sensor raw data, identifying patterns within the union set by comparing data points of the union set, classifying the identified patterns as usual patterns or unusual patterns, creating a visual image from the received sensor raw data, annotating a location of any identified unusual patterns in the visual image, and providing the visual image to a display device. A system and a non-transitory computer-readable medium are also disclosed.

### BACKGROUND

Digital image acquisition can be used to capture physical images of the interior structure of an object. Conventional digital image acquisition can include acquiring raw data of the object of interest, and then processing the raw data to produce images, compressing the images, storing, and displaying the images.

Classification of digital imaging techniques can be on the basis of the source of the signal used to obtain the raw data—for example, scalar radiation (ultrasound), vector electromagnetic radiation (x-ray). Ultrasound measurement data is based on the detection of reflected signal strengths, and x-ray measurement data is based on signal strength after passing through the object. For conventional techniques, after interacting with the object of interest a sensor/detector receives the signal (reflected or transited), which is then electronically processed by a computing device to generate a visible-light image. Conventional approaches and systems then store this visible-light image electronically as a digital file.

For example, digital tomosynthesis is an imaging technique that allows volumetric reconstruction of the whole object of interest from a finite number of projections obtained by different x-ray tube angles. This technique involves taking a series of x-ray images (projections) with an x-ray tube (also called the x-ray source) at different positions while the detector and object are either relatively stationary or in relative motion. Current systems use either a step-and-shoot configuration, where the tube (or detector) is stationary during x-ray exposure, or a continuous motion configuration, where the tube (or detector) is constantly moving but the x-rays are pulsed during the motion. The number of x-ray exposure cycles corresponds to the number of stationary positions or to the number of pulses respectively. Ultrasound techniques operate in a similar fashion, only with reflected signals. Either technique generates massive amounts of data points, which then are used to create digital visible-light image files that require enormous amount of processing power and time, plus vast memory stores.

### BRIEF DESCRIPTION OF THE DRAWINGS

FIG. 1 depicts a conventional 3D image data capture process;

FIG. 2 depicts a 3D image data capture process in accordance with embodiments;

FIG. 3 depicts a flowchart of 3D image processing with predictive auto-annotation generation in accordance with embodiments;

FIG. 4 depicts a system for 3D image processing with predictive auto-annotation generation in accordance with embodiments; and

FIG. 5 depicts an auto-annotated image generated in accordance with embodiments.

### DETAILED DESCRIPTION

In accordance with embodiments, systems and methods process the voluminous data obtained by three-dimensional (3D) scanner devices to create a visualization of at least a portion of the scanned volume of an item-under-study. Embodying systems and methods can generate predictive auto-annotation(s) in the visualization during the data processing. Image classification and image analysis is performed at the time of signal data capture (e.g., absorptive or reflective returns from the item-under-study). This approach to capturing, storing, classifying, and analyzing the captured raw data produced during scanning provides more efficiency over conventional approaches, thus eliminating machine learning processes required under the prior art. Such improvement can result in faster processing and less memory requirement. By providing annotations in the displayed results, faster diagnosis and/or identification of anomalies in the item-under-study can be achieved with an increased accuracy over conventional approaches.

Embodying systems and processes can be implemented independent of the nature and type of Image acquisition system. For example, image data can be obtained by capturing the level of reflections when an item-under-study is illuminated with the image acquisition source (e.g., ultrasound technology is one such example). Equally applicable, image data can be acquired by capturing the level of signal absorption when the item-under-study is placed along a path that is between a source and detector (e.g., x-ray, MRI, PET, CT are a few examples).

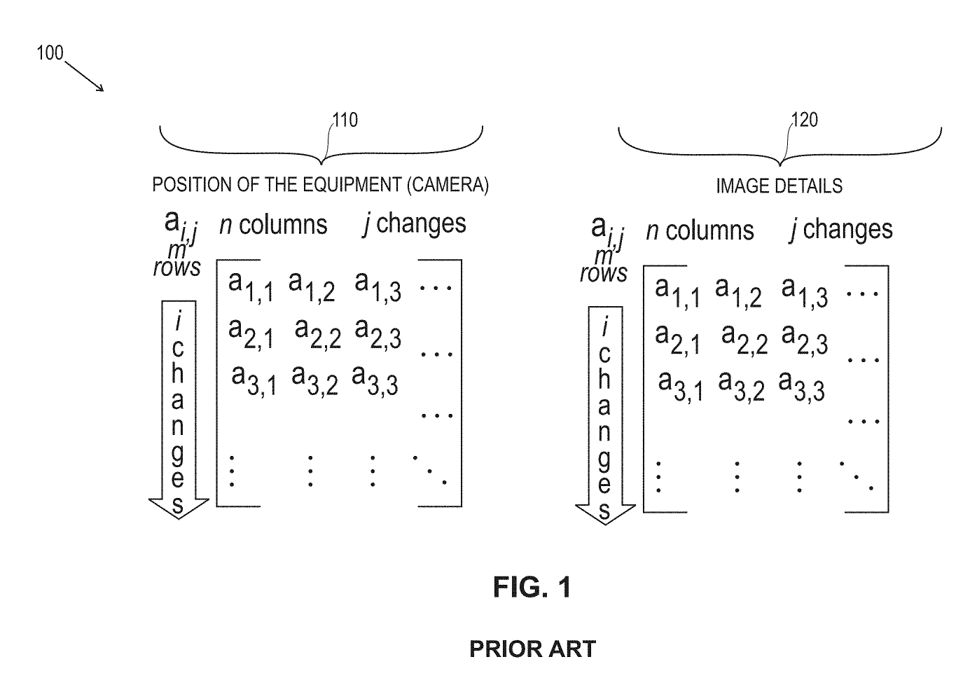

FIG. 1 depicts conventional 3D image data capture process 100. Three-dimensional raw data obtained be scan systems (e.g., CT, MRI, ultrasound) are captured as space and dimension data. For instance, as a signal source is moved across an item-under-study, an image capture device (e.g., camera, detector, etc.) samples the signal.

Either of the source, the capture device, or the item-under-study can be moved. Movement can be in a singular plane or along an arc path. Ultrasound technology keeps the item-under-study position constant, and moves the source/detector. CT/MRI and PET technology are examples where the item-under-study, source and detector each move relative to one another.

Conventionally, 2D images are stored in image format (e.g., .png, .gif, .jpg, etc.) for normal images and specialized formatting (such as Digital Imaging and Communications in Medicine (DICOM), JPEG2000 image compression for medical images, etc.). The position of the image capture device/detector can be stored in spatial orientation array 110, and formatted image stored as in pixel image value array 120, where the pixel corresponds to an image capture device position. By storing the captured raw data in image format, conventional approaches lose information which is irretrievable, thus any image processing loses key information.

The conventional image processing approaches superimpose multiple captured images to reconstruct a 3D image. The conventionally-created 3D mage has the fundamental flaw of being created from 2D images by software that remaps the 2D images into a 3D array of images. Then machine learning is applied after the remapped 3D image is produced.

The conventional process stores data in image format, which are typically large file sizes (e.g., 5-6 megabytes each image), where a typical MRI could require 100-1,000 or more images contained in 4-19 scan series.

Storage requirement for one MRI image could be 1000 images×5 megabytes≥5 gigabytes. If the MRI is to image the beating of a heart, when the ability of the human eye to recognize movement is factored in, approximately at least thirty-two frames per second are required. To generate this moving image on a display screen, 32 frames×5 megabytes>160 megabytes of image processing per second. This quantity of processing requires powerful processing ability and massive data store resources.

Even for the display of still images, diagnosticians (e.g., radiologists, etc.) often seek to rotate the displayed image. To achieve the rotation, conventional approaches apply deep learning machine algorithms to isolate the pixel image data of array 120 (e.g., by row and/or column) into multiple layers of arrays to then perform the rotation.

These deep learning algorithms are attempting to identify hidden layers of the images, to separate into multiple layers, and identify correlation among object contours to generate the rotated output view. To perform this task, conventional approaches assume that the image data of array 120 is static and immutable to perform this image manipulation. There are two, false assumptions that conventional approaches are dependent on to achieve the rotation. The first assumption is that the raw data generates immutable images of what was captured. The second assumption is that separating the images into multiple layers has a high degree of accuracy, which is not true. These assumptions can lead to false or phantom image creations, which can then lead to completely false/incorrect diagnosis based on image artifact(s) that never really existed. Thus, conventional approaches result in rotated images that can provide inaccurate result. Critical applications (e.g., medical imaging) can suffer from these inherent assumptions.

Under conventional approaches, identification of an anomaly in the item-under-test is performed by image processing software acting on the stored image formatted data. The image processing software scans the pixel values of the images and then attempts to identify unusual patterns and/or transitions. Often the results are not reliable, thus a diagnostician (e.g., a radiologist) needs to view the voluminous quantity of images to make judgmental decisions on the anomalies. Conventional pattern analysis is premised on the recognition of similarities between the image of the item-under-test and historical data.

In accordance with embodiments, captured raw data is not converted to image format for storage. Rather embodying systems and methods apply reverse machine learning to individual data points to store the results in a pixel matrix array containing detailed information regarding each raw data point. The image capturing solution is to store images as mathematical models of multiple dimensional arrays. Data manipulation to generate images can be performed by processing software adapted to use mathematical models to render the displayed images faster than the conventional methods. Contrary to conventional analysis based on historic data, embodying systems and methods perform image analysis predicated on information captured in the present image.

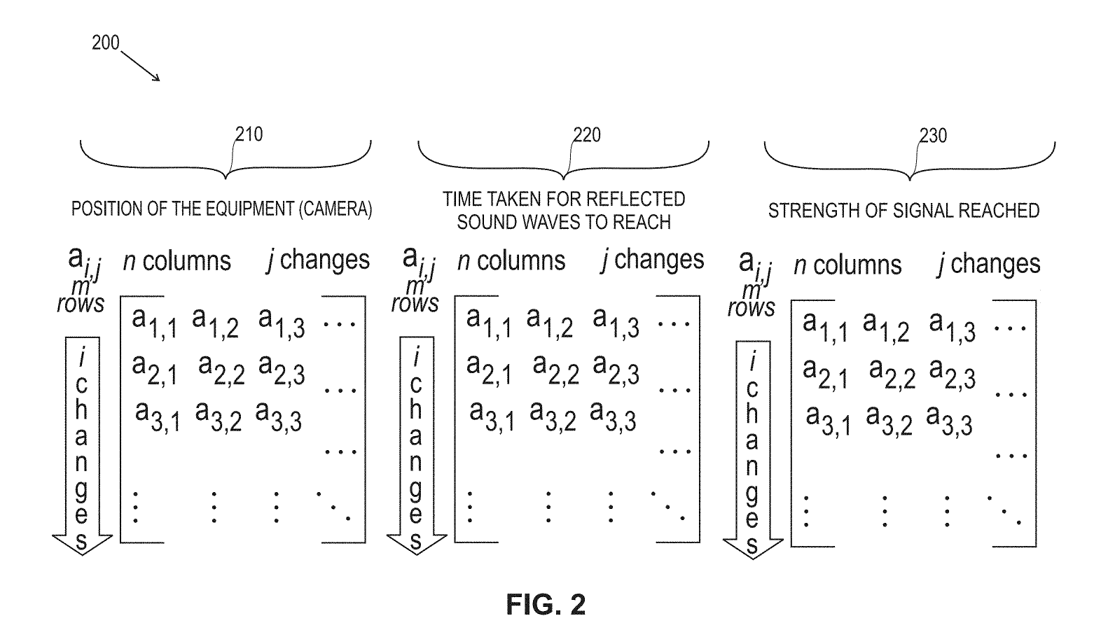

FIG. 2 depicts 3D image data capture process 200 in accordance with embodiments. Captured raw image data is stored as mathematical models of multiple dimensional arrays. For example, matrix array 210 can include information regarding the position of the source/detector/item-under-study (relative to each other or absolute). Matrix array 220 can include signal travel time. Matrix array 230 can include signal strength information of a reflected (ultrasound) or absorbed (MRI) wave.

From the raw data arrays, image generation and visualization can be obtained in 3D format by using the image layers directly from the array matrixes—for example, [spatial orientation delta]×[pixel signal value delta]. Image classification is performed faster and more efficiently than conventional approaches. Because the classification/analysis is based on captured raw data from a sensor (e.g., transducer, detector, etc.), as opposed to stored image formats, results have a greater accuracy than the conventional approaches.

Because the delta in pixel values is readily available through a simple mathematical subtraction/addition, image reconstruction can be loaded at a greater speed. Generating moving display images needing thirty-two frames per second can be achieved quickly, with less processing and memory demand. Embodying systems and methods apply reverse machine learning (i.e., learning from raw data storage rather than deep learning from distorted images) to allow system hardware (image capture device and memory) to work in tandem with software to construct the 3D images.

By applying reverse machine learning to the captured raw image data, generation of annotations on the displayed image can be done automatically with improved accuracy to provide a prediction of medical conditions (cancer, tumor, diseased tissue, fractures, etc.). Such accurate automated generated annotations are completely missing from conventional approaches.

In accordance with embodiments, captured raw image data is stored a mathematical model of multiple dimensional arrays so that the identification of unusual patterns in the data is simpler than the conventional approach of pixel reading of a stored image file.

By way of example, Table 1 contains two matrix arrays—time of reflection and pixel signal intensity for an ultrasound scan.

TABLE I

| Object Spatial | |
|---|---|
| Orientation | Pixel Intensity |
| [2, 3, 3] | [12, 3, 4, 5] |
| [2, 3, 4] | [12, 3, 4, 15] |
| [2, 3, 5] | [12, 3, 4, 12] |

Mathematically, it can be easily derived that there is a possibility of cancer at the location 2, 3, 4 as the intensity of the pixel suddenly (abruptly) changes from a value of “5” to “12” in the last term. Embodying systems and methods implement mathematical models that analyze the raw data obtained during image capture (e.g., time of reflection/sensor data). When the image is displayed, the raw data is converted to a representation of pixel intensity. In accordance with embodiments, these mathematical models are implemented in conjunction with hardware sensitive to pixel intensity to identify the range of pattern change across locations. Thus, embodiments provide greater accuracy than conventional approaches that merely implement machine learning comparisons to stored historical image data.

By way of example, a very low intensity value could be a soft tissue reflection, thus indicating a potential cancer knot. In accordance with embodiments, a delta in adjacent data points can be visualized as heat maps using an object's marking as contours, which clearly call attention to issues in that region of the item-under-study.

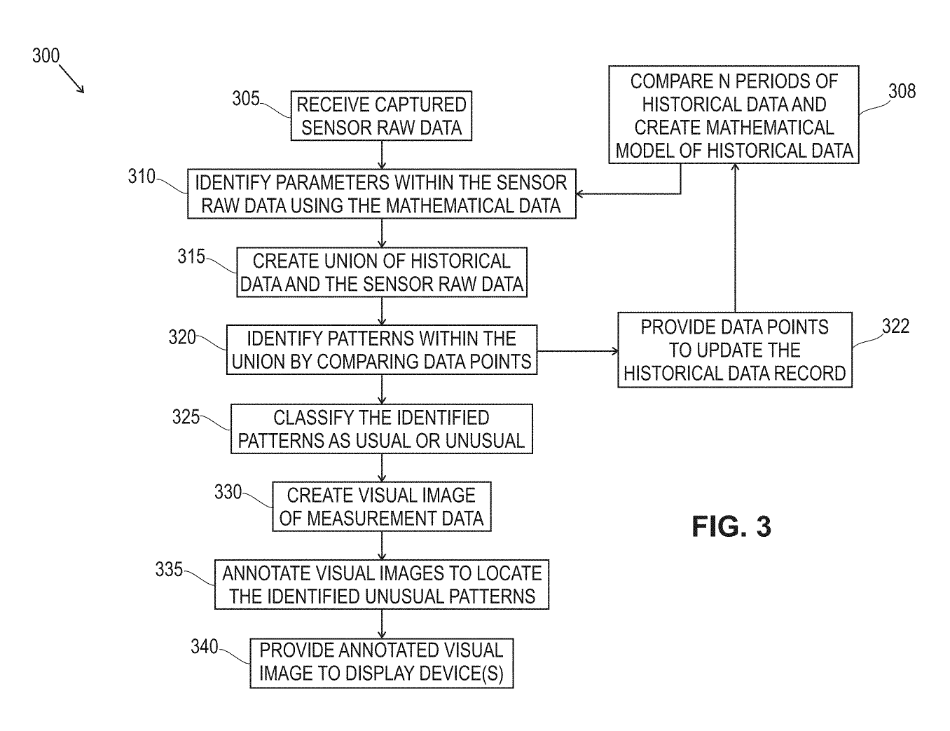

FIG. 3 depicts a flowchart of process 300 for 3D image processing with predictive auto-annotation generation in accordance with embodiments. Captured raw image data is received, step 305. The raw image data can include signal dependent (reflected and/or absorbed signal levels) and scanner system dependent information (positional information). The raw data can be stored in array matrixes. In some implementations, an image acquisition system can provide image formatted data. In such instances, the image formatted data can be transformed to its constituent raw image data components.

Parameters within the image data can be identified by mathematical processes, step 310. For example, sudden change in signal intensity across object contours and/or between object contours groupings can be identified. To identify the parameters, mathematical models of historical data can be applied to the captured data. The historical data mathematical models can be created, step 308, by comparing N periods of historical data to generate patterns.

By way of example, suppose a pelvis scan is being performed by an ultrasound device on a female patient. The ultrasound data can include object contours that delineate boundaries between objects—the objects in a pelvic scan can include, for example, bladder, uterus, rectum, symmetric gas scatter, and other structures. Embodying processes perform anomaly detection using the object contours discernable in the sensor (ultrasound transducer, x-ray detector, etc.) raw data obtained during the scan. This sensor raw data is used to create mathematical models of raster contours.

These mathematical models can be used in conjunction with historical data. Historical data can include scan data obtained from prior scans performed on about the same area on other patients. For example, after performing many scans a basis of expected object contours can be developed. Abnormality annotation by embodying systems can include analysis that considers the mathematical models, the sensor raw data, and the historical data.

In some implementations, anomaly detection can be done in a region of the sensor data local to the object contours as opposed to analyzing the sensor raw data for the entire scan. The object contours can be automatically detected based on the mathematical models and historical data. By constraining anomaly detection to regions local to contours, the time expended in identifying the presence of an anomaly is reduced, along with memory requirements and processor overhead.

A union of historical data and the captured data is created, step 315. Patterns within the captured data is identified, step 320, from the union set by comparing data points. The data points can be provided, step 322, to the historical data record.

The identified patterns can be classified, step 325, as usual (e.g., transition from soft tissue to bone, etc.) or unusual (e.g., tumor, etc.). A visual image of the captured data can be created, step 330. Any unusual patterns identified in the image (step 325) can be automatically annotated, step 335. The annotation can be inserting a border, an arrow, or other identifying mark and/or indicator into the rendered image. At step 340, the annotated visual image is provided to a display device.

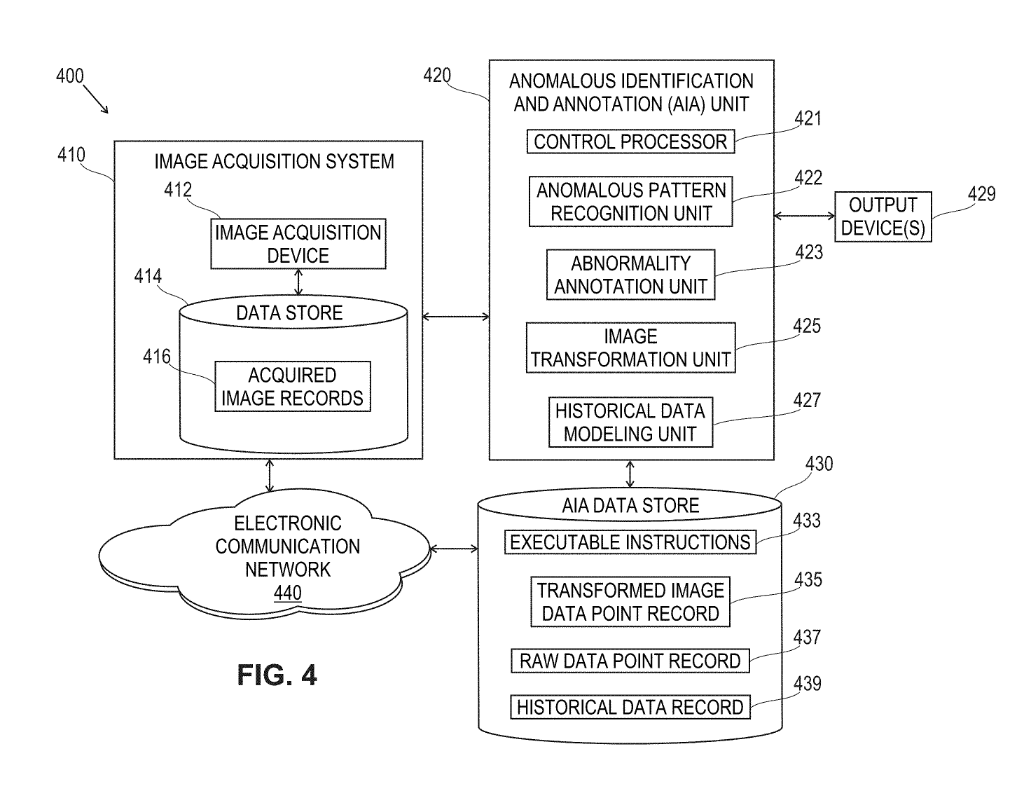

FIG. 4 depicts anomalous identification and annotation (AIA) system 400 for 3D image processing with predictive auto-annotation generation in accordance with embodiments. AIA system 400 can include AIA unit 420 that includes control processor 421, which can be in communication with AIA data store 430 either directly and/or across electronic communication network 440. Control processor 421 can access executable instructions 433 in data store 430, which causes the control processor to control components of AIA unit 420 to support embodying operations by executing executable program instructions 433. Dedicated hardware, software modules, and/or firmware can implement embodying services disclosed herein.

AIA unit 420 can be local to image acquisition system 410. Image acquisition system 440 can include image acquisition device 412 and data store 414. Within data store 414 acquired image records 416 can be a repository for captured images and/or captured raw data obtained by scanning an item-under-study. In some implementations, the AIA unit can be remote to the image acquisition system. In remote implementations, the AIA unit can be in communication with one or more image acquisition systems across electronic communication network 440.

Electronic communication network 440 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 440.

AIA unit 420 can include image transformation unit 425 configured to transform captured images into constituent raw data—i.e., measured signal strength, source/detector positional information, etc. Raw data point record 437 can contain raw data received from image acquisition system 410. Transformed image data point record 435 can contain the raw data transformed by the transformation unit. Historical data modeling unit 427 can access historical data record 429 and perform comparisons between the historical data record and either of raw data record 439 and transformed image data point record 435.

Anomalous pattern recognition unit 422 can analyze the results of the comparison between the historical data record and the raw (or transformed) data. Recognition of anomalies can result in abnormality annotation unit 423 annotating an image. The image produced by AIA unit 429 can be transmitted to display devices (e.g., monitor, display, printer, tablet, smart phone, etc.)

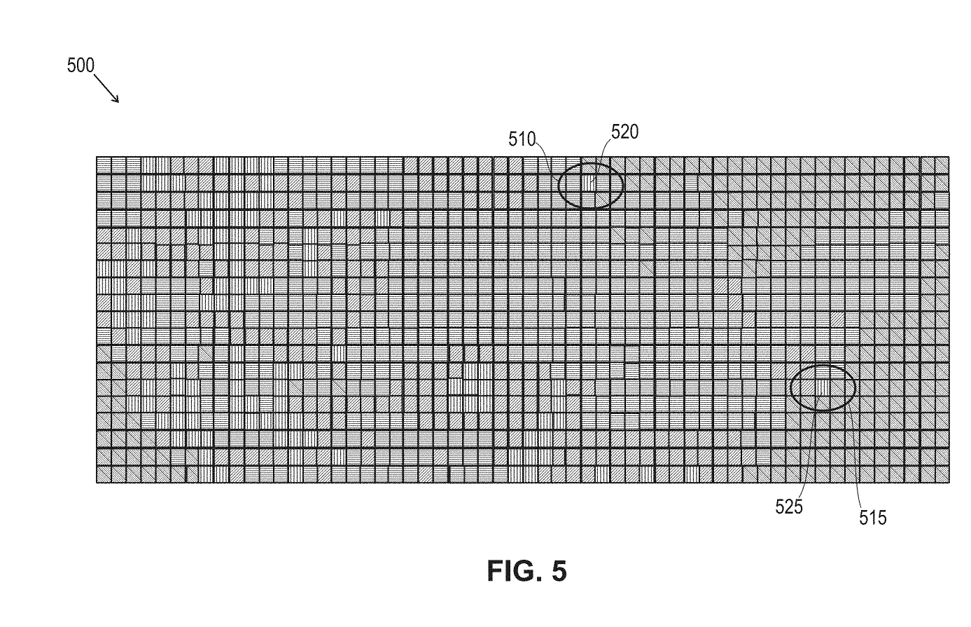

FIG. 5 depicts auto-annotated image 500 generated in accordance with embodiments. Annotated image 500 is illustrated with annotation areas 510, 515. The annotation areas are generated by abnormality annotation unit 423 of the AIA unit automatically and without user intervention. Within each annotation area 510, 515 is respective image anomaly 520, 525.

The image anomalies can be identified by applying reverse machine learning to raw image data. By examining changes between data pixels, the anomalies can be identified. For example, a cancer tissue surrounded by normal soft tissue could exhibit very different radiation emission/reflection values with sharp changes between object contours.

Conventional images provide a diagnostician (e.g., a Radiologist) with images, which are then annotated by the diagnostician manually. In accordance with embodiments, AIA unit 420 generates the annotations automatically to highlight issues identified within the item-under-study.

Although embodying systems and methods are discussed in the context of medical imaging, this disclosure is not so limited. It should readily be understood that embodiments can be applicable to other application of image capture, and are not limited to just medical diagnosis.

In accordance with embodiments, video images can be rendered at a greater speed than conventional approaches with less demand for processor power and memory allocation. To render an image of a mammalian heart beat from the captured raw data, typically thirty-two frames per second are needed to be rendered on a display monitor.

Conventional approaches focus on raster (or other) graphic video processor with a commensurate demand for a large allocation of memory. Under conventional approaches, first one image is rendered on the display, then a subsequent image, then another, and so on to simulate the moving image. This conventional approach has disadvantages related to first losing key elements of data due to compression loss and conversion of 3D data points to a 2D image. Also, loading a large file with an image (e.g., MRI image file can be about 3 megabytes per image) at thirty-two images per second requires allocation of extensive memory.

In accordance with embodiments, raw captured image data points are stored as a mathematical multi-dimensional array. From the raw data, a first image is painted on the display. Subsequent images to form the moving image are painted as a delta of the image pixels from the first image, as are subsequent images. Because many pixels are stationary, embodying systems and processes require a significant reduction in memory allocation and processor demand.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable program instructions that when executed may instruct and/or cause a controller or processor to perform methods discussed herein such as a method for 3D image processing with predictive auto-annotation generation based on analyzing sensor raw data, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

I claim:

1. A method of three-dimensional image processing with predictive auto-annotation generation, the method comprising:
receiving sensor raw data, the sensor raw data captured by an image acquisition system;
identifying parameters within the sensor raw data using historical data;
creating a union set of the historical data and the sensor raw data;
identifying patterns within the union set by comparing data points of the union set;
classifying the identified patterns as usual patterns or unusual patterns;
creating a visual image from the received sensor raw data;
annotating a location of any identified unusual patterns in the visual image; and
providing the visual image to a display device.

2. The method of claim 1, the received sensor raw data including one of raw captured image data and formatted image data.

3. The method of claim 1, including:
identifying one or more object contours in the sensor raw data; and
creating the union set only using historical data and sensor raw data to a region local to the one or more object contours.

4. The method of claim 1, the image parameters including at least one of signal intensity change between object contours and between object contours groupings.

5. The method of claim 1, including comparing periods of historical data to create the historical mathematical data.

6. The method of claim 1, including providing the union set data points to augment the historical data.

7. The method of claim 1, the classifying identified patterns including comparing the identified patterns to patterns within the historical data.

8. The method of claim 1, classifying the identified patterns including comparing an intensity change between object contours with a predetermined threshold.

9. A non-transitory computer-readable medium having stored thereon instructions which when executed by a control processor cause the control processor to perform a method of three-dimensional image processing with predictive auto-annotation generation, the method comprising:
receiving sensor raw data, the sensor raw data captured by an image acquisition system;
identifying parameters within the sensor raw data using historical data;
creating a union set of the historical mathematical data and the sensor raw data;
identifying patterns within the union set by comparing data points of the union set;
classifying the identified patterns as usual patterns or unusual patterns;
creating a visual image from the received sensor raw data;
annotating a location of any identified unusual patterns in the visual image; and
providing the visual image to a display device.

10. The non-transitory computer-readable medium of claim 9, the instructions further configured to cause the control processor to perform the method, including the received sensor raw data including one of raw captured image data and formatted image data.

11. The non-transitory computer-readable medium of claim 9, the instructions further configured to cause the control processor to perform the method, including:
identifying one or more object contours in the sensor raw data; and
creating the union set only using historical data and sensor raw data to a region local to the one or more object contours.

12. The non-transitory computer-readable medium of claim 9, the instructions further configured to cause the control processor to perform the method, the image parameters including at least one of signal intensity change between object contours and between object contours groupings.

13. The non-transitory computer-readable medium of claim 9, the instructions further configured to cause the control processor to perform the method, including comparing periods of historical data to create the historical mathematical data.

14. The non-transitory computer-readable medium of claim 9, the instructions further configured to cause the control processor to perform the method, including providing the union set data points to augment the historical data.

15. The non-transitory computer-readable medium of claim 9, the instructions further configured to cause the control processor to perform the classifying identified patterns by including comparing the identified patterns to patterns within the historical data.

16. The non-transitory computer-readable medium of claim 9, the instructions further configured to cause the control processor to perform the classifying the identified patterns by including comparing an intensity change between object contours with a predetermined threshold.

17. A system for three-dimensional image processing with predictive auto-annotation generation, the system comprising:
an anomalous identification and annotation unit including a control processor, the control processor configured to access computer executable instructions that cause the control processor to perform a method, the method comprising:
receiving sensor raw data, the sensor raw data captured by an image acquisition system;
identifying parameters within the sensor raw data using historical data;
creating a union set of the historical data and the sensor raw data;
identifying patterns within the union set by comparing data points of the union set;
classifying the identified patterns as usual patterns or unusual patterns;
creating a visual image from the received sensor raw data;
annotating a location of any identified unusual patterns in the visual image; and
providing the visual image to a display device.

18. The system of claim 17, the received sensor raw data including one of raw captured image data and formatted image data, the control processor configured to access computer executable instructions that cause the control processor to perform a method, the method including:
identifying one or more object contours in the sensor raw data; and
creating the union set only using historical data and sensor raw data to a region local to the one or more object contours.

19. The system of claim 17, the control processor configured to access computer executable instructions that cause the control processor to perform a method, the method including classifying identified patterns by including comparing the identified patterns to patterns within the historical data.

20. The system of claim 17, the control processor configured to access computer executable instructions that cause the control processor to perform a method, the method including classifying the identified patterns by including comparing an intensity change between object contours with a predetermined threshold.
